(19) United States
(12) Patent Application Publication
(10) Pub. No.: US 2007/0159011 A1
(43) Pub. Date: Jul. 12, 2007

(54) Optimized electrical generators

(76) Inventors: Berj A. Terzian, Newbury, MA (US); Jack A. Ekchian, Belmont, MA (US)

Correspondence Address: LUCAS & MERCANTI, LLP, 475 PARK AVENUE SOUTH, 15TH FLOOR, NEW YORK, NY, 10016, US

(21) Appl. No.: 11/328,661

(22) Filed: Jan. 10, 2006

(51) Int. Cl. H02K 7/18; F03G 7/08; H02K 35/00

(52) U.S. Cl. 310/15; 290/1 R

(57) ABSTRACT

An electrical generator and a method of generating electricity are achieved by utilizing a disc-shaped permanent magnet having opposite faces with opposite magnetic poles. The magnet is rolled through a passageway having electrically conductive conductors that intersect the magnetic flux lines of the rolling magnet, thereby generating electrical voltage and current in the conductors. This system can be included in a wide range of products or devices to self generate therein operating or stored electrical power, especially products or devices that are portable by a human being or other living creature.

### BACKGROUND OF THE INVENTION

1. Field of the Invention

This invention relates to electrical generators which can be utilized as power sources for various devices and products, especially those which are portable and thus capable of self generating operating or stored power without the need for access to an external source of electricity.

2. Disadvantages in Prior Systems

The present applicants are co-inventors of prior inventions described in earlier filed copending applications, Ser. No. 11/120,255, entitled “Self Powered Cell Phone”; Ser. No. 11/130,093, entitled “Automated Motion Provider for Self Powered Cell Phones”; Ser. No. 11/191,890, entitled “Armature Type Electrical Generators for Self Powered Cell Phones”; and Ser. No. 11/199,309, entitled “Enhanced Internal Electrical Generators”, the disclosures of which are incorporated by reference herein.

These prior systems are based on permanent magnets moving through conductive wire spirals or coils and designed such that the wire conductors intersect the magnetic flux lines of the moving magnets to generate electric voltage and current in the conductors by the Faraday effect.

Some of these systems involve spherical or cylindrical magnets sliding through raceways having external wire coils surrounding tubular cross sections to enable such motion. However, frictional resistance is encountered in such motion which limits the velocity and/or acceleration that the magnets can reach.

Others of the prior systems involve magnets that oscillate on pendulum-like armatures swinging adjacent wire coils. These require ball bearing pivots to maximize the capability of the swinging motion of the armatures with the least amount of friction. Such bearings are costly, occupy significant internal space within a device or product and are difficult to manufacture and assemble.

### 3. SUMMARY OF THE INVENTION

The present invention overcomes or mitigates the above noted difficulties of the prior systems by utilizing disc-shaped permanent magnets the opposite faces of which comprise opposite magnetic poles. These magnets are inserted in passageways which have complementary cross sectional shapes that enable the magnetic discs to freely roll on their edges through the passageways. This simplifies both the components and the manufacturing and assembly of electrical generators designed to function in this manner. As a result, electrical generators constructed and operated in accordance with the present invention are optimized for use as internal electrical power sources for a wide variety of consumer devices and products, without any need for an external source of electricity.

### 4. BRIEF DESCRIPTION OF THE DRAWINGS

Further details of the invention will be readily understood by reference to the following drawings of which:

FIG. 1 is an exploded perspective view of one embodiment of the invention.

FIG. 2 is a magnified cross sectional view of the components of FIG. 1 assembled for use as an electrical generator.

FIGS. 3A, 3B and 3C are cross sectional views of another embodiment of the invention.

FIGS. 4A and 4B are additional views of the FIG. 3 embodiment.

### 5. DETAILED DESCRIPTION OF THE INVENTION

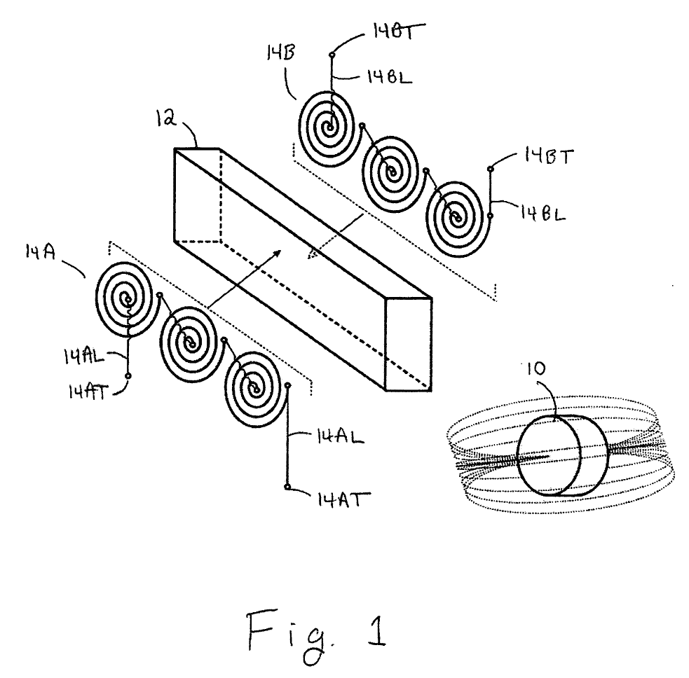

Referring to FIG. 1, illustrated there is a disc-shaped permanent magnet 10. The opposite circular faces are north and south poles of the magnet. The magnetic flux extends between these poles in imaginary lines that form a magnetic envelope surrounding the magnet.

The magnet is shaped and dimensioned to be inserted on its edge within a passageway 12 having a complementary cross section. That is to say, the passageway provides a tunnel for the magnet having slight clearances of space between its internal walls and the surfaces of the magnet.

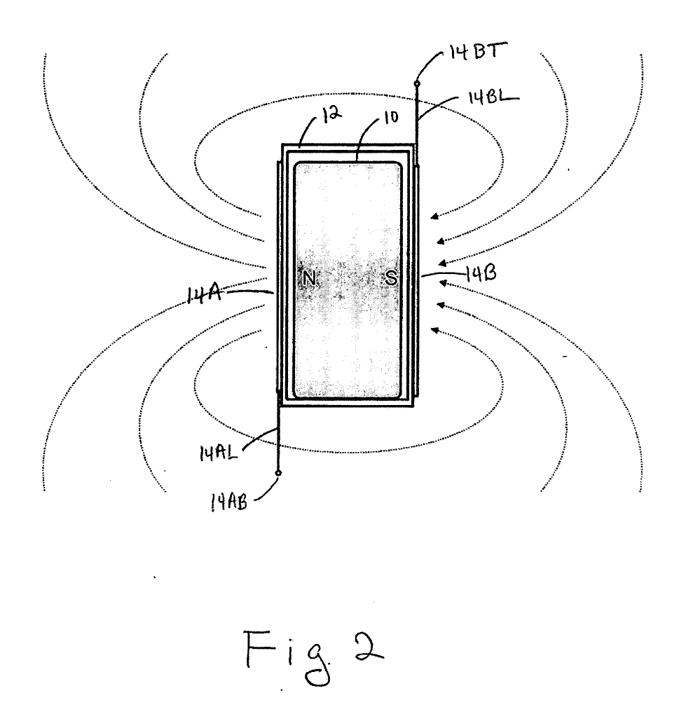

These clearances can be seen in the FIG. 2 cross sectional view of the passageway 12 and the magnet 10 after the latter has been placed within the passageway. The bottom edge 14 of the magnet 10 is resting upon the floor of the passageway 12, and the remaining surfaces of the magnet are spaced slightly away from the side and top walls of the passageway.

FIG. 1 includes two banks 14A and 14B of electrically conductive conductors, each bank comprising triple, interconnected wire spiral coils, with the end spirals connected to output leads and terminals, 14AL and 14AT in the lower bank, and 14BL and 14BT in the upper bank. The individual coils and banks of coils may be connected in series or parallel to achieve the desired voltage and current.

The banks 14A and 14B are fixed against the sidewalls of passageway 12. As illustrated in FIG. 2, the assembled components comprise magnetic disc 12, within the interior space of passageway 12 and with wire spiral coil banks 14A and 14B flanking the interior space on the side walls of passageway 12.

When this assembly is vertically oriented as represented in FIG. 2 and tilted about a horizontal axis through the passageway's sidewalls, the gravitational force will cause magnetic disc 10 to roll on its edge toward the lower end of the passageway. The magnetic flux lines will be substantially perpendicularly intersected by the wire coils of the banks 14A and 14B, thus optimally producing electrical voltage and current in the coils. This current can be transmitted through the leads 14AL, 14BL and terminals 14AT, 14BT to an electrically or electronically operated device or product for use as operational or stored electrical power.

Those skilled in the art will appreciate that the electrical generator illustrated in FIGS. 1 and 2 achieves simplicity, optimal functionality and cost effectiveness. Only three simple components are required. The passageway 12 is preferably constructed of non-conductive materials, such as a PCB substrate, for example, to avoid magnetically induced eddy current effects. The wire spirals are preferably deposited as printed circuits in one or more layers on the passageway's side walls comprising such substrate material.

Tilting of the passageway 12 to cause the magnetic disc 10 to roll therethrough can be carried out in repeated opposite directions, clockwise and counterclockwise, to cause generation of electrical currents of opposite polarities on a substantially continuous basis. Such tilting can be performed manually by a user, or automatically with various mechanical means as described in copending applications Ser. No. 11/133,093, entitled “Automated Motion provider for Self Powered Cell Phones”, and Ser. No. 11/199,309, entitled “Enhanced Electrical Generators”. The frequency of such repeated oscillations can be readily synchronized so that the magnetic disc 10 is caused to switch between its rolling opposite directions just when it reaches the lower end of the passageway 12 and begins to tilt in the opposite direction, thus achieving substantially continuous generation of voltage and current. The opposite polarities of such current can be converted into direct current by transmitting the opposite polarities, for example, to a full wave diode rectifier as described in copending application Ser. No. 11/120,255, entitled “Self Powered Cell Phone.”

The rectified direct current can be transmitted, for example, to rechargeable batteries or capacitors in a wide range of consumer devices or products, for example, cell phones, MP3 players, I-pods, digital cameras, video players, video game players, laser beam levels, satellite ground locators, inclinometers, radios, pagers, Blackberrys or other personal digital assistants, or flashlights.

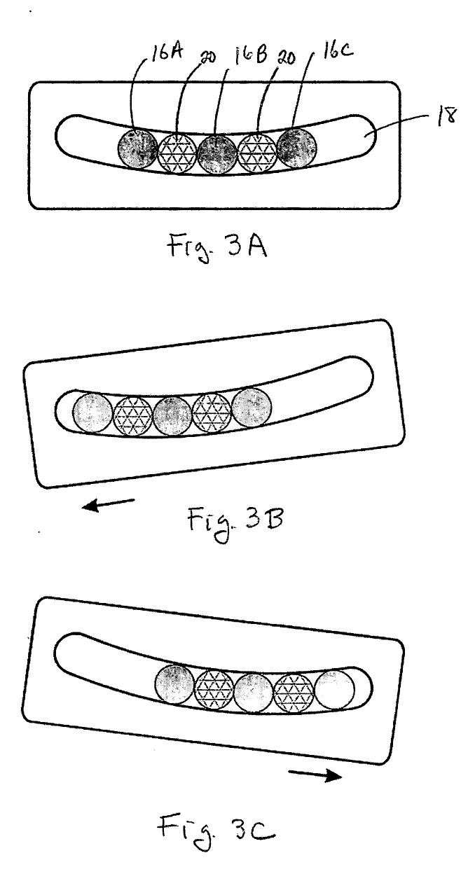

FIGS. 3A, 3B and 3C illustrate another embodiment of the invention in which three disc-shaped magnets 16A, 16B and 16C are placed within a passageway 18 which has a length that is arcuate. Interspersed between these magnets are spacer discs 20A and 20B. When the passageway 18 is tilted in opposite directions about a horizontal axis through the passageway's side walls, the train of magnetic and spacer discs rolls toward the lower end of the passageway, with the magnets maintained in a uniform spacing apart from each other, thus causing dampening and smoothening of the generated electric current.

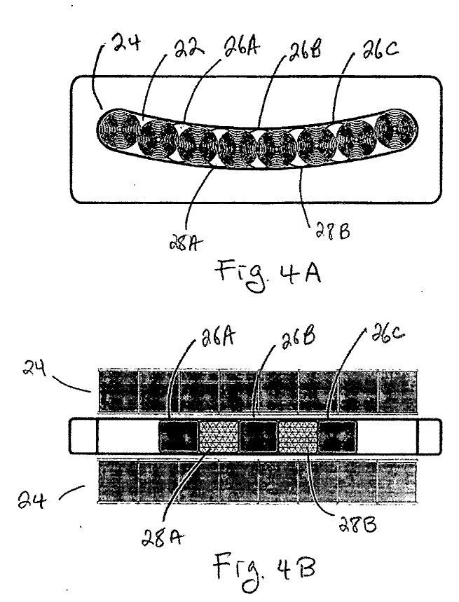

FIGS. 4A and 4B provide additional views of the FIG. 3 embodiment. In particular, FIG. 4A is a side view of passageway 22 which again has an arcuate length and a bank of eight wire spiral coils 24 flanking the passageway on both of its sidewalls. As seen in the cross sectional view through the top of the passageway in FIG. 4B, within passageway 22 are three magnetic discs 26A, 26B and 26C separated from each other by spacer discs 28A and 28B. Again, this passageway 22 can be tilted in opposite directions about a horizontal axis to cause the train of magnetic and spacer discs to roll toward the lower ends of the passageway, as it fluctuates between clockwise and counterclockwise directions, with the dampening and smoothening effects discussed in connection with FIGS. 3A, 3B and 3C.

The invention has been described in terms of its functional principles and several embodiments. Many variations of such embodiments will be apparent to those skilled to the art. In essence, the invention can be practiced with one or more disc-shaped magnets in one or more passageways configured and dimensioned to enable the magnetic discs to roll through the passageway, the latter having one or more groups or patterns of electrically conductive conductors, arranged to intersect the magnetic flux lines of the rolling magnetic discs, thereby generating electrical voltage and current in the conductors. Also, multiple banks of such generators can be stacked in a device, product or housing and connected in parallel to an output lead to increase the magnitude of the generated current.

In the application and use of such generators, one illustrative example is to incorporate an embodiment in a cell phone and connect its output to the cell phone's rechargeable battery. If such a phone is placed in a holster or other carrier attached to a person's body, for example, an arm, leg or hip, the normal motions of such body parts during the course of a day will generate sufficient electrical current to maintain the cell phone operable during that period. Similarly, such cell phones can be kept charged for blind persons by being carried in holsters secured to their seeing eye dogs. Likewise, the tracking collars of endangered wildlife species can be kept operable by including a generator embodiment of the invention in a pouch or other holder on such collars. In fact, electrically or electronically operated consumer devices or products that are portable by a human being or other living creature can be kept operable by generators made and used in accordance with the invention, as described above.

The utility of the invention in non-portable applications can be exemplified in oceanographic devices. For instance, floating buoys can be equipped with one or multiple, electrically interconnected banks of the FIG. 1 embodiment, and the action of ocean waves, currents or tides will maintain the generators in substantially continuous tilting motions to generate voltage and current that will, for example, illuminate warning lights on the buoys in the dark. Likewise, tethered, submerged transponders which emit or detect various signals in oceanography can be kept electrically powered by similar generation of current by an embodiment of the invention while obviating the need for servicing the device to keep the power on.

Before closing, it should be noted that, while rolling of the magnetic discs on their edges through the passageways is the ideal manner of operating the invention, as previously described, as a practical matter this cannot be expected to occur at all times during tilting of the passageways about a horizontal axis. Since there are clearances between the internal passageway walls and the surfaces of the discs, and since it is not possible to always maintain the discs in a perfectly vertical orientation, the discs will likely wobble slightly and glance off, or rub or slide against, the passageway walls as they move down the tilted passageways. Furthermore, it is preferable for the corner edges at the faces of the disc to be slightly rounded both to enhance rolling motion and to minimize distortion of the magnetic flux lines which can occur from sharp, right-angled corners. Therefore, the term “rolling” in context of the present invention is not to be interpreted as requiring absolute or perfect rolling of the discs through the passageways without any contact between the two. Even with a perfect vertical orientation, the discs will move with random slight glancing, rubbing, sliding or similar occasional contacts with the passageway walls, and it is hereby defined that such motions and contacts are within the scope of the term “rolling”.

In fact, in some extraordinary circumstances, sliding contact between one face of a magnetic disc and an internal wall of the passageway may be advantageous. For example, if a cell phone containing the FIG. 1 embodiment of the invention becomes depleted of stored electrical power and needs to be recharged, in a remote location where electricity or a mechanical charger is unavailable, manual recharging can be performed by the user. To do so, the phone can be held in his or her hand, with the arm bent at the elbow at a right angle, and the phone tilted in opposite directions by similar rotations of the wrist. Sustaining such motions for a long time can cause fatigue. In that case, the arm can be lowered into a vertical position and the phone oscillated in opposite directions through a horizontal plane, again by similar rotations of the wrist. This will cause the magnetic disc to slide its bottom face over the sidewall of the passageway beneath it in alternate directions, thus relieving fatigue and continuing to generate voltage and current to recharge the phone.

The important point is that in the generators of this invention, the axis of the magnetic flux lines is always oriented in substantial perpendicularity relative to the length of the passageway. Therefore, whatever the position of the generator in space, there will be optimum generation of voltage and current due to the perpendicular intersection of the magnetic flux lines by the conductive conductors when the generator is oscillated in opposite directions. Accordingly, the term “rolling” of the magnetic discs is hereby defined to mean and encompass all of the foregoing descriptions of how the invention can be carried out. Likewise, equivalent flat magnets having non-circular perimeters and sliding through the passageways are within the scope of the invention and the term “rolling”

It should be understood that it is intended to cover all variations or modifications of the illustrative embodiments of the present invention that fall within the scope of the appended claims and all equivalents thereof.

The following is claimed:

1. An electrical generator which comprises:
at least one disc-shaped permanent magnet the opposite faces of which comprise opposite magnetic poles,
at least one passageway configured to enable the disc-shaped magnet to roll on its edge therethrough,
said passageway including at least one group of electrically conductive conductors formed in a pattern which intersects the disc-shaped magnet's magnetic flux lines as the magnet rolls through the passageway,
whereby electrical voltage and current are generated in the conductors by the rolling motion of the disc-shaped magnet through the passageway.

2. An electrical generator according to claim 1 wherein the passageway has a rectangular cross section with dimensions that provide clearances between it and the surfaces of the disc-shaped magnet, so that the magnet can optimally roll through the passageway.

3. An electrical generator according to claim 1 wherein when the disc-shaped magnet and the passageway are disposed in a vertical orientation, tilting of the passageway about a horizontal axis through the passageway's sidewalls causes the disc-shaped magnet to roll through the passageway toward its lower end, thereby generating electrical current of one polarity in the conductors.

4. An electrical generator according to claim 3 wherein when the passageway is tilted in opposite directions about the horizontal axis, the disc-shaped magnet is caused to roll through the passageway in opposite directions, thereby generating electrical currents of opposite polarities in the conductors.

5. An electrical generator according to claim 4 wherein the electrical currents generated in the conductors are connected to a circuit which outputs electrical current having a single polarity.

6. An electrical generator according to claim 5 wherein the circuit includes a rectifier which is connected to a storage device.

7. An electrical generator according to claim 6 wherein the storage device is a battery or a capacitor.

8. An electrical generator according to claim 7 wherein the battery is rechargeable.

9. An electrical generator according to claim 1 comprising a multiplicity of disc-shaped magnets each disposed in one of a multiplicity of passageways, whereby multiple voltages and currents are simultaneously generated in the patterns of electrical conductors as the multiple disc-shaped magnets roll through the multiple passageways.

10. An electrical generator according to claim 9 wherein the generated multiple electrical currents are transmitted through parallel connectors to at least one storage device.

11. An electrical generator according to claim 1 disposed within an electrically operated device and connected to provide operating electrical power or stored electrical power to the device.

12. An electrical generator according to claim 11 wherein the electrically operated device is portable by a human being or other living creature.

13. An electrical generator according to claim 12 wherein the electrically operated device is a cell phone, an MP3 player, an I-pod, a digital camera, a video player, a video game player, a satellite ground locator, a laser beam level, an inclinometer, a radio, a pager, a Blackberry or other personal digital assistant, or a flashlight.

14. An electrical generator according to claim 1 coupled to means for tilting the passageway in opposite directions about a horizontal axis through the passageway's sidewalls while both the passageway and magnet are disposed in a vertical position, thereby causing the disc-shaped magnet to roll in corresponding opposite directions through the passageway to generate electrical voltage and current of opposite polarities in the electrical conductors.

15. An electrical generator according to claim 14 wherein the electrical currents generated in the conductors are connected to a circuit which outputs electrical current having a single polarity.

16. An electrical generator according to claim 14 wherein the tilting means comprises a mechanical device which automatically tilts the passageway in repeated opposite directions to generate electrical currents substantially continuously in the conductors during such tilting.

17. An electrical generator according to claim 1 wherein the pattern of the conductive conductors comprises a printed circuit deposited on a passageway constructed of non-conductive material.

18. An electrical generator according to claim 17 wherein pattern comprises at least one concentric spiral coil.

19. An electrical generator according to claim 17 wherein the pattern comprises at least one substantially sinusoidal or saw tooth wave form of predetermined frequency with the peaks thereof pointing in a direction substantially parallel to the length of the passageway.

20. An electrical generator according to claim 1 wherein the length of the passageway is straight.

21. An electrical generator according to claim 1 wherein the length of the passageway is arcuate.

22. An electrical generator according to claim 1 wherein the length of the passageway is partially straight and partially arcuate.

23. A method of generating electricity which comprises:
providing at least one disc-shaped permanent magnet the opposite faces of which comprise opposite magnetic poles,
providing at least one passageway configured to enable the disc-shaped magnet to roll on its edge therethrough,
said passageway including one group of electrically conductive conductors formed in a pattern that intersects the disc-shaped magnet's magnetic flux lines as the magnet rolls through the passageway, and
causing the disc-shaped magnet to roll through the passageway,
thereby generating electrical voltage and current in the conductors as a result of their intersection of the magnet's magnetic flux lines.

24. A method according to claim 23 which includes tilting the passageway about a horizontal axis through the passageway sidewall to cause the disc-shaped magnets to roll in one direction therethrough, thereby generating electrical current of one polarity in the electrical conductors.

25. A method according to claim 23 which includes tilting the passageway about the horizontal axis in opposite directions to cause the disc-shaped magnet to roll therethrough in opposite directions, thereby generating electrical current of opposite polarities in the electrical conductors.

26. A method according to claim 25 which includes transmitting the generated electrical current to a circuit and outputting therefrom electrical current having a single polarity.

27. A method according to claim 26 which includes transmitting the current to a storage device.

28. A method according to claim 27 which includes transmitting the current to a battery or a capacitor.

29. A method according to claim 28 which includes transmitting the current to a battery which is rechargeable.

30. A method according to claim 26 which includes transmitting the current to an electrically operated product and operating the product with said current.

31. A method according to claim 30 which includes transmitting the rectified current to a cell phone, an MP3 player, an I-pod, a digital camera, a video player, a video game player or a laser level beam, an inclinometer, a radio, a pager a Blackberry or other personal digital assistant.

32. A method according to claim 23 which includes forming the pattern of electrical conductors by depositing it as a printed circuit on a passageway constructed of non-conductive material.

33. A method according to claim 32 which includes forming the pattern of electrical conductors as at least one concentric spiral coil.

34. A method according to claim 32 which includes forming the pattern of electrical conductors as a substantially sinusoidal or sawtooth waveform with the peaks thereof pointing in a direction substantial parallel to the length of the passageway.

35. A method according to claim 23 which includes forming the length of the passageway in a straight shape.

36. A method according to claim 23 which includes forming the length of the passageway in an arcuate shape.

37. A method according to claim 23 which includes forming the length of the passageway in a partially straight and partially arcuate shape.
